(19) United States
(12) Patent Application Publication
(10) Pub. No.: US 2003/0130866 A1
(43) Pub. Date: Jul. 10, 2003

(54) System and method for facilitating the care of an individual and dissemination of infromation

(76) Inventors: Kathryn C. Turner, Bethesda, MD (US); Veronica Oberdorf, Olney, MD (US); Gopal V. Raja, Reston, VA (US); Gail M. Maestas, Herndon, VA (US); Howard Epstein, Rockville, MD (US)

Correspondence Address: SWIDLER BERLIN SHEREFF FRIEDMAN, LLP, 3000 K STREET, NW, BOX IP, WASHINGTON, DC, 20007, US

(21) Appl. No.: 10/038,907

(22) Filed: Jan. 8, 2002

(51) Int. Cl. G06F 17/60

(52) U.S. Cl. 705/2

(57) ABSTRACT

The present invention is a system and method for facilitating the process of caring for an individual, such as an elder. The present invention also disseminates a wide range of information to users. The system allows members of an elder's support group to easily and conveniently communicate and coordinate their actions. The present invention is accomplished by the creation of an “e-space” for the elder. The e-space is a set of data files that are associated with the elder. The e-space is stored in a central location that can be accessed conveniently by individuals by accessing a computer network such as the Internet. The system also allows the elder (or an agent of the elder called a “responsible party”) to maintain his or her privacy by controlling access to his or her e-space. This is accomplished by providing the elder or responsible party the ability to specify varying levels of access privileges for each type of data file in his/her e-space for each member of his/her support group. The system also allows the elder to delegate privileging power to an administrator or official at the care provider facility where he or she is residing. The administrator/official can then grant access privileges to members of the care provider staff. The system also provides a variety of information and tools which assist individuals in making decisions related to elder care.

### FIELD OF THE INVENTION

The present invention relates generally to a system and method for facilitating the coordination of the care of any individual, such as an elder with diminished physical and/or mental capacity, who resides in primarily a long-term care facility and/or a home care environment or any other healthcare facility. More specifically, the present invention relates to a system and method for the providing a data space associated with an individual that is easily accessible by users on a computer network. Additionally, the present invention relates to a system and method for simple routing of requests made from individuals to groups, and tracking those requests though to resolution.

### BACKGROUND OF THE INVENTION

Many people, at some point in their lives, have to cope with the heavy burden of arranging for the care of an aging parent or loved one. When an elder starts to show signs of becoming sick or unable to care for themselves safely, often a daughter or son of the elder must start thinking about whether the elder will need some type of assistance, and what form that assistance should take. In the beginning, it may be sufficient to arrange for an assistant to visit the elder's home on a periodic basis. As the elder's condition worsens, however, the elder may eventually have to be placed in a nursing facility or some other form of assisted living facility.

Usually, the elder's family members and support group face a multitude of tasks that need to be accomplished. The family members have to decide whether to put the elder in some form of care provider facility. They may have to arrange the sale of the elder's home, deal with disposition of belongings, coordinate with the bank and the realtor and so forth.

In the hustle and bustle of today's modern world, the challenges of coordinating with family members to arrange care for an elder and make decisions regarding their situation can be daunting. Each family member has his/her own busy schedule, which often doesn't match the schedules of the other family members. For example, a daughter who lives in Virginia might have to discuss plans with her brother, who lives in California, and her sister who is stationed in the military out in Germany. The parties probably will end up spending large amounts of time on the telephone, calling and recalling, leaving messages, discussing what needs to be done, what are the outstanding issues, who should assume responsibility for which tasks, and so forth.

Even after an elder has been placed in a care provider facility, there are still difficult problems of coordination between family members and the staff of the care provider facility. For example, suppose an elderly woman residing in a long-term care facility (LTC) has a doctor's appointment scheduled at a physician's office outside of the LTC facility. The daughter of the elder calls the physician's office to make the appointment. She likely also has to call the LTC facility several times. Suppose the daughter calls the LTC facility in the evening and speaks with the evening nurse. The daughter requests that the elder be ready to go out at 11:00 am. The daughter also requests that the staff get a certain dress ready for the elder to go out for a meal. The evening nurse then has to communicate the details of the doctor's visit to the daytime nurse. The daytime nurse then tells the Certified Nursing Assistant that this particular elder has an appointment at 11:00 a.m. and won't be around for lunch. Additionally, there are many other communications required internal to the LTC facility. For example, the housekeeping staff, the nurses, and the dietary staff must be informed. Thus, there are many internal and external communications that are required, all centered around getting the elder ready to go to that doctor's appointment and out for lunch afterwards. What is needed is a system and method that can facilitate the communications and coordination between an elder's support group members and the care provider staff, and also facilitate communications internal to the care provider staff.

Another problem faced by the care provider facility is when every member of an elder's family or support group individually calls the care provider facility and overwhelms the care provider staff with questions concerning the elder's well being, or to participate in care planning sessions, or plan some event for the elder. In some cases, maybe one daughter or son will be a pivotal person to coordinate everything. However, the daughter or son has to make multiple a phone calls to the rest of the elder's support group to let everyone else know what is happening and what needs to be done.

Another problem associated with care of the elder is that over the elder's life, the elder may be transferred to a number of different types of care settings. For example, the elder may initially be able to get by with having an in-home assistant. As the elder ages, they may need to be transferred to an assisted living facility or nursing facility. Each time the elder moves to a new facility, a significant amount of paperwork must be filled out or transferred to the new facility. For example, the elder's insurance information, medical history, contact information, religious information, dietary preferences, and so forth must be transferred from the old facility or reentered into the computers at the new facility.

What is needed is a system that provides a convenient method of communicating and coordinating between all the individuals involved in caring for the elder. What is also needed is a resource for anyone seeking information concerning the support or care of a particular elder. This system must maintain the privacy of an elder, and allow the elder or responsible party to finely control who has access to his or her private information.

Also, the system must maintain accountability, so that a request may be made to a group, such as “Nursing Home Care Staff”, and the system will ensure that one and only one person responds to the request and that the request may only be considered closed or satisfied by the request initiator. Furthermore, the system must manage information presentation, so that users are not overloaded with information. The system must tailor information presentation for each user, so that only important and relevant information for that user is in plain view. Finally, what is needed is a system and method that facilitates the care of an elder from a very early stage when an elder is just starting to have problems associated with aging, through the time when the elder is admitted to a care provider facility, and up until the death of the elder.

### SUMMARY OF THE INVENTION

The present invention facilitates the process of caring for any individual, such as an individual with diminished physical or mental capability. Throughout this application, examples and descriptions are provided regarding the care of an elder; however, this invention is not limited to the care of an elder but can be extended to the care of any individual, or to the interaction between any groups of people, where one person in a group has a need to communicate with any one person of another group and needs to track an issue involving that group. The system further facilitates the dissemination of information to users. The system allows members of the elder's support group to easily and conveniently communicate and coordinate their actions. The “support group” of the elder includes not only the elder's family and friends, but anyone else involved in the care of that elder or has some interaction with the elder. For example, the elder's support group can include the elder's daughter, son, cousin, doctor, nurse, social worker, financial advisor, insurance agent, attorney, banker, real estate agent, clergy, and so forth.

The present invention is accomplished by the creation of an “e-space” for the elder. The e-space is a set of data files that are associated with the elder. The e-space is stored in a central location that can be accessed conveniently by individuals anywhere in the world at anytime. For example, data files in an e-space can include the elder's medical information, financial records, general well being messages, dietary preferences, shopping lists, e-mail messages, and a myriad of other types of data files that will be discussed in more detail below.

Members of the elder's support group can conveniently access the elder's e-space from anywhere in the world simply by accessing a computer network such as the Internet. Thus, the present invention provides a great convenience and simplification of the burden of coordinating among the numerous individuals that interact with elder.

The present invention also allows the elder (or an agent of the elder called a “responsible party”) to maintain his or her privacy by controlling access to his or her e-space. This is accomplished by providing the elder or responsible party the ability to specify varying levels of access privileges for each type of data file in his/her e-space for each member of his/her support group.

The present invention also allows the elder to delegate privileging power to an administrator or official at the care provider facility where he or she is residing. The administrator/official can then grant access privileges to members of the care provider staff.

The present invention also includes a method and process for managing “Casual Workflow” (CWM). According to the process for managing workflow, users are assigned into groups. Any user may make a request of any group or groups. The groups include one or more possible respondents to the request. As the request is being made to the members of the groups, they may be designated at requestees. The Workflow Manager according to the present invention helps ensure that one and only one member of a requestee group responds to the request. Additionally, the workflow manager provides a range of communications tools that can help to ensure that an ensuing “Conversation” regarding a request can be viewed and commented on according to user access privilege. One aspect of the Casual Workflow Manager that makes it distinct and separate from other workflow managers is that CWM has no preconceived notion of workflow. The workflow is generated dynamically, and not preprogrammed into the system.

The present invention may also include a “Smart View” method and system. According to Smart View, users are presented only with information and controls that are relevant to them. The information is sorted in order of importance. The importance may relate to time sensitivity of an item or to a need to respond to an item or any other desired factor. This process may be fully automatic and not require user activation or selection of filters or sorting mechanisms or user specification of rules.

The system of the present invention also provides a variety of information and tools which assist individuals in making decisions related to elder care. The system of the present invention provides other types of e-spaces such as a care provider e-space. The care provider e-space contains various types of information related to the care provider such as policies, procedures, newsletters and employee training information.

### BRIEF DESCRIPTION OF THE DRAWINGS

FIG. 1 depicts a block diagram illustrating a system architecture suitable for implementing the present invention.

FIG. 2 depicts a block diagram illustrating the logical relationships between the elder and his or her support group.

FIG. 3 depicts an example of a display screen that is shown when a member of the elder's support group reads a message posted on the “General Well Being” file in the elder's e-space.

FIG. 4 displays an example “History” screen for an elder's General Well-Being file.

FIG. 5 depicts a flowchart illustrating a registration process.

FIG. 6 depicts an example of a “registration” display screen.

FIG. 7A depicts example default privilege settings for a Responsible Party and the Care Provider Staff.

FIG. 7B depicts example default privilege settings for a Family Member and for other associates, friends or parties interested in the Elder's care.

FIG. 8 depicts an example of a table specifying a set of default privileges that are granted to the care provider staff according to their roles.

FIG. 9 displays a sample home page that provides resources for Internet users facing a variety of different elder-care situations and problems.

FIG. 10 depicts a flowchart illustrating a process performed by the crisis assistance tool.

FIG. 11 depicts an embodiment of a display screen that may be shown to illustrate requests received from users.

FIGS. 12-16 depict embodiments of various display screens that might be displayed to family members of an individual being cared for by the system in the course of the operation of the system.

FIGS. 17-19 depict embodiments of various display screens that might be displayed to employees of a facility caring for an individual under the care of the system in the course of the operation of the system.

### DETAILED DESCRIPTION OF THE PRESENT INVENTION

The present invention facilitates the process of caring for an individual by providing a system which allows members of the individual's support group to easily and conveniently communicate and coordinate their actions. Throughout this application, examples and descriptions will be provided regarding the care of an elder; however, this invention is not limited to the care of an elder but can be extended to the care of any individual, or to the communications and tracking of issues between multiple groups.

The “support group” of the elder includes not only the elder's family and friends, but anyone else involved in the care of that elder or has some interaction with the elder. For example, the elder's support group can include the elder's daughter, son, cousin, doctor, nurse, social worker, financial advisor, insurance agent, attorney, banker, real estate agent, clergy, and so forth.

The present invention is accomplished by the creation of an “e-space” for the elder. The e-space is a set of data files that are associated with the elder. The e-space is stored in a central location that can be accessed conveniently by individuals anywhere in the world at anytime. For example, data files in an e-space can include the elder's medical information, financial records, general well being messages, dietary preferences, shopping lists, e-mail messages, and a myriad of other types of data files that will be discussed in more detail below.

Members of the elder's support group can conveniently access the elder's e-space from anywhere in the world simply by accessing a computer network such as the Internet. Thus, the present invention provides a great convenience and simplification of the burden of coordinating among the numerous individuals that interact with elder.

The present invention also allows the elder (or an agent of the elder called a “responsible party”) to maintain his or her privacy by controlling access to his or her e-space. This is accomplished by providing the elder or responsible party the ability to specify varying levels of access privileges for each type of data file in his/her e-space for each member of his/her support group.

The present invention may also include a “Casual Workflow” manager. The workflow manager may be implemented according to the invention whether or not the other aspects of the invention are implemented in a particular embodiment. Along these lines, any process or portion of a process may be combined with the Casual Workflow manager. Additionally, due to its wade applicability, the workflow manager may be implemented in other applications that have purposes other than the purpose described herein. Therefore, the Casual workflow manager may facilitate coordination of care of an individual or may be involved in other services.

According to the implementation of the Casual Workflow manager in the present invention, a request is received from a user. The request may be transmitted over any medium. For example, the request may be transmitted over the internet or an intranet.

The request is transmitted to at least one group of potential respondents and may be transmitted to a plurality of groups. Each group of respondents may include one or more members. The user may select the group(s) of respondents and/or the group(s) of respondents may be automatically selected. According to one embodiment, the requests are automatically routed to an administrator or a party responsible for overseeing care of an individual that a request relates to. A response is transmitted to the user from only one respondent. The respondents to the request are then limited to the one respondent who transmits a response, thereby preventing additional respondents from responding to the request.

Once a response is transmitted, an indication may be produced to the user who generated the request. After the user has viewed the response, the indication of a response may be deleted. The request may be discussed between the user and the respondent until the request is resolved. When other users are authorized to view the user's communications, the other users may transmit comments concerning the request to the user and/or the respondent.

As described above, other respondents are cut off once one of the respondents that receives the request transmits a response. However, the respondent may extend the request to other respondents or groups of respondents for any reason, such as to obtain additional advice. Once the request is satisfied, a message communicating such may be transmitted to the user.

Users transmitting request may be assigned into groups. Each group may include only one member. Any individual may make a request of any group. The Workflow Manager ensures that one and only one member of the requestee group responds to the request, and provides a range of communications tools to ensure that the ensuing “Conversation” can be viewed and commented on according to user access privilege. What makes the “Casual Workflow Manager (CWM)” distinct and separate from other workflow managers is that CWM has no preconceived notion of workflow. The workflow is generated dynamically, and not preprogrammed into the system.

This Casual Workflow concept is supported by several system Action Verbs; namely “Announce”, “Request”, “Comment”, “I Can Help”, “I Need Help”, “No Response Required”, “Response Required”, “Working”, and “Thank You”. These Action Verbs are used in the context of a Conversation, which has a Requestor and one or more Respondents. Finally, “Smart View” manages the display of all of this activity, presenting information only when it is relevant for a particular user.

The Casual Workflow concept is further supported by dynamic groups. Users may belong to a single group, which is their “Home Group”. By default, any Conversation initiated by a user is visible and can be commented upon by all users in that user's Home Group. For example, in the context of care of an individual, a family member may initiate a Request to the Greenwood Nursing Home group, asking whether they can bring a pet to visit their mother. All members of the Greenwood Nursing Home group see this Request. When one person in the Greenwood Nursing Home group presses “I Can Help”, then the Conversation vanishes for all other members of that group because the Smart View concept described herein deems it irrelevant. The staff member indicates that pets are allowed, and that he will send out a form. He posts this message, pressing “No Response Required”. This is a mechanism for requesting that the conversation be closed. The family member reads the response, is satisfied, and presses “Thanks”, which closes the conversation.

Typically, Casual Workflow controls are all context-sensitive. That is, only the initiator of a request ever sees a “Thank You” button associated with that request, and only if a Respondent has requested closure (“No Response Required”).

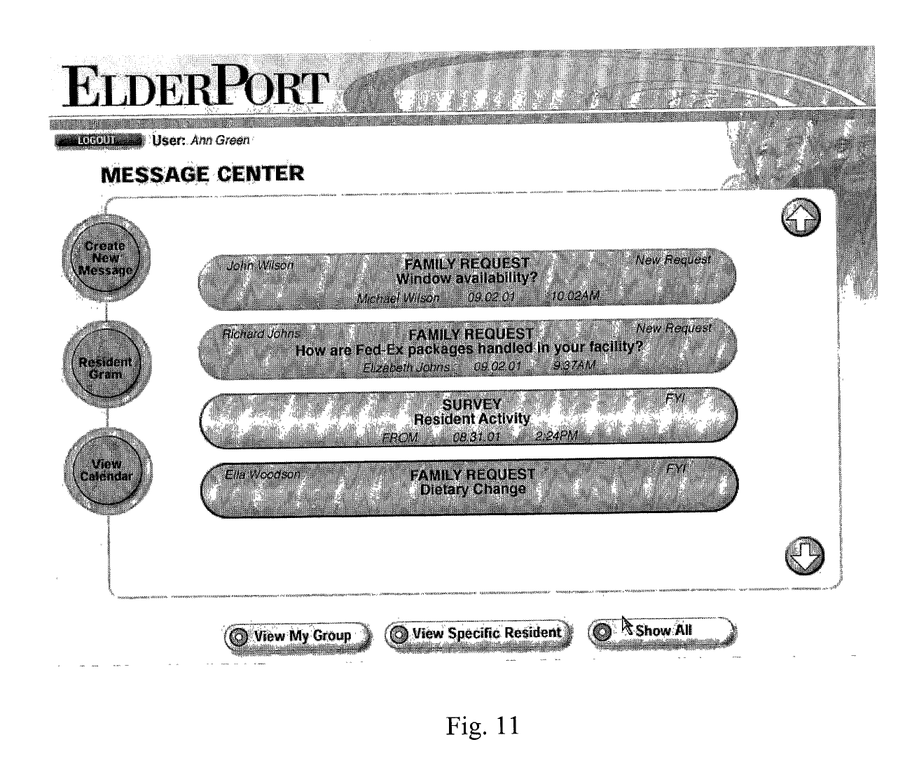

The hub of ElderPort communication management is the Message Center, an embodiment of which is depicted in FIG. 11. Each Conversation that is relevant to a user appears as a Conversation Button. The appearance and relative ordering of Conversation Button may depend upon one or more factors. Examples of factors that may be utilized can include the identity of the user, the Elder, the type of Conversation, the urgency of the Conversation, the system state of the Conversation, and the user state of the Conversation. Examples of Conversation types can include Announcement or Request. Also, examples of the system state of the Conversation can include “New Request”, “Awaiting Closure”, and “Working”. Furthermore, examples of the user state of the Conversation can include “Awaiting Response”, “FYI”, and “New Messages”. Of course, other classifications could be utilized for any of the factors. Additionally, other factors could also be utilized.

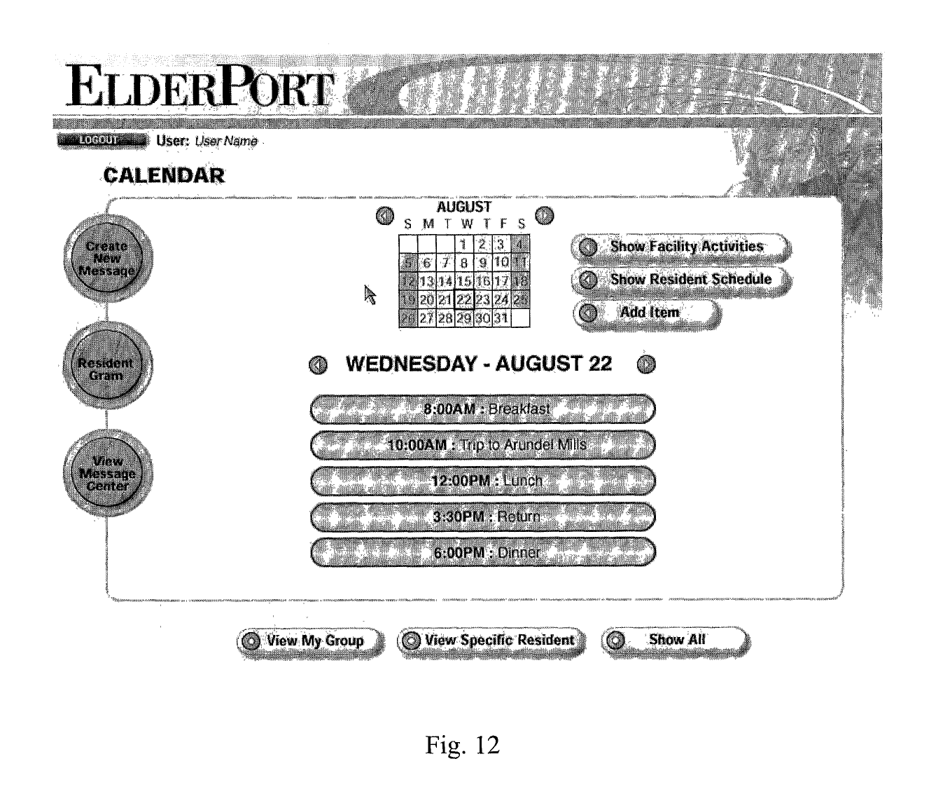

FIGS. 12-16 illustrate embodiments of display screens that might be displayed to family members or other designated parties during the course of care of an individual. Along these lines, FIG. 12 illustrates an embodiment of a display screen that includes a calendar for an individual whose care is being coordinated by the system. This embodiment of a calendar display screen includes a depiction of the month with the ability to select a day and have the schedule for that particular day displayed on the screen as shown in FIG. 12. Active clickable buttons may be included on the page to initiate selected actions. Along these lines, clicking on one of the buttons can result in the display of information, such as the “Show Resident Schedule” button on the display screen shown in FIG. 12. Clicking on a button can also initiate an action, such as the “Create New Message” button on the display screen shown in FIG. 12. Buttons may added to any initiate actions other than those shown in FIG. 12 if desired. Similarly, it is not necessary that the buttons shown in FIG. 12 be included.

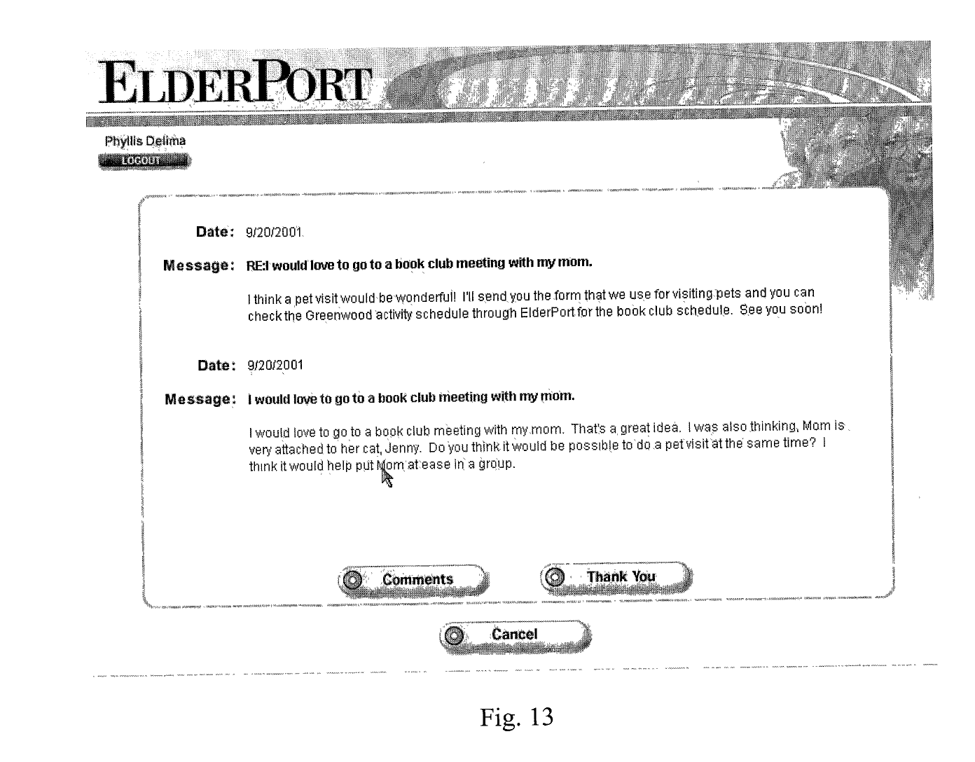

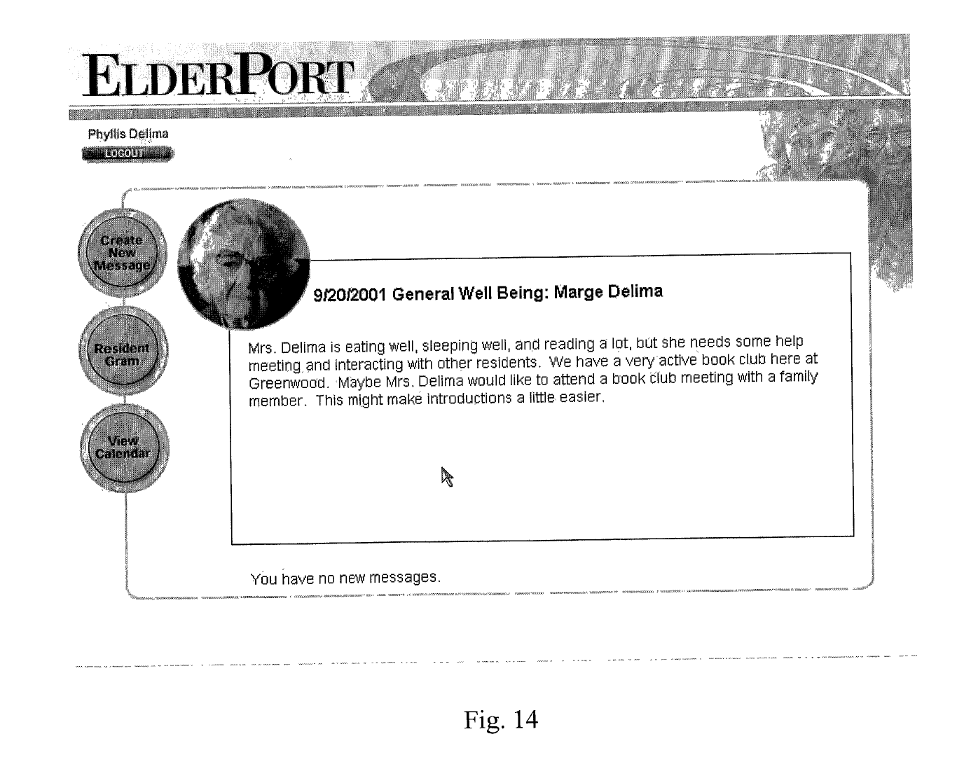

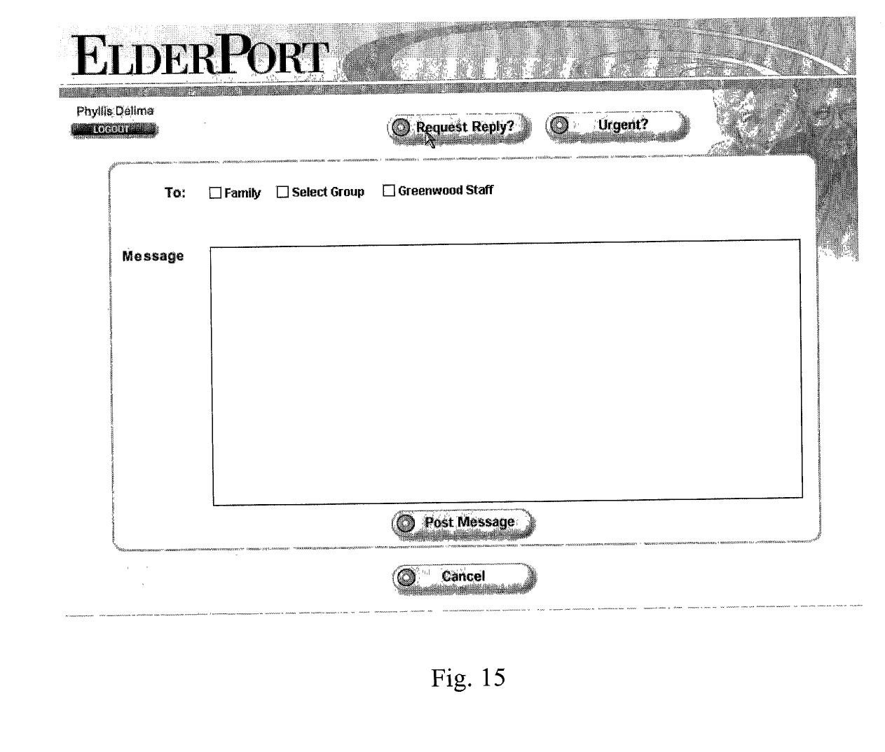

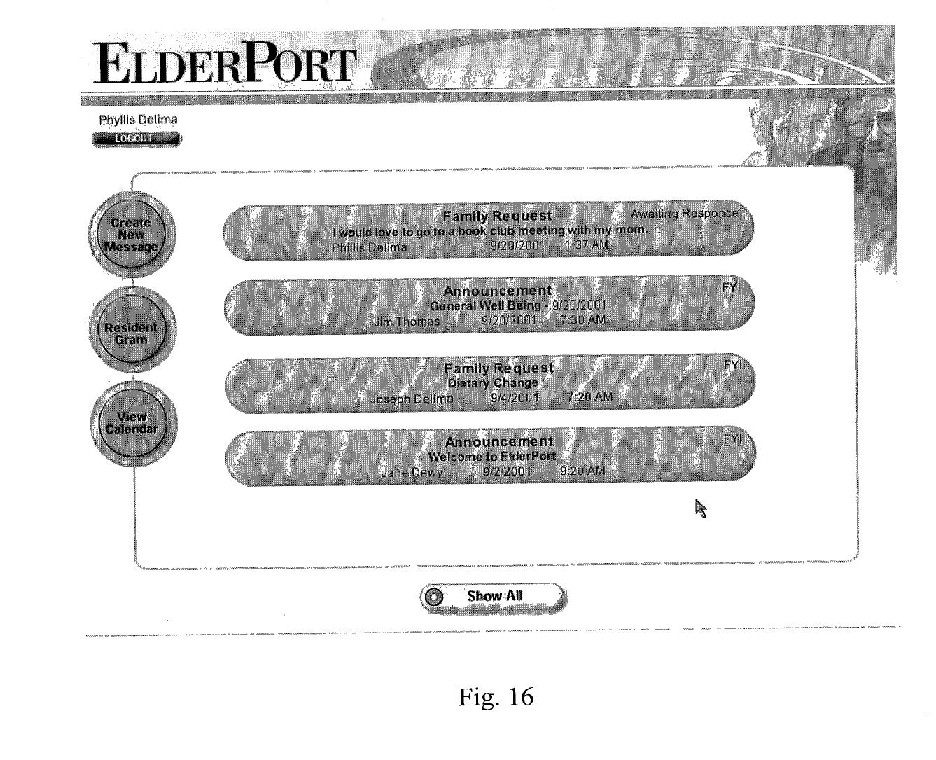

The system may include other display screens that show different information and/or provide links to further information or initiation of various actions. For example, FIG. 13 illustrates an embodiment of a display screen that shows messages sent from a family member of an individual to a care facility. Additionally, FIG. 14 illustrates an embodiment of a display screen that shows a response received from an individual at a care facility to an inquiry message from an individual's family member or other authorized person. FIG. 15 illustrates an embodiment of a display screen for permitting an individual to generate a message to members of various groups. Any group may be included in possible recipients. Additionally, each individual utilizing the system may have a different level of authority and therefore, the individuals that may receive a message may be different for each user. FIG. 16 illustrates an embodiment of a display screen that shows messages sent and received by an individual.

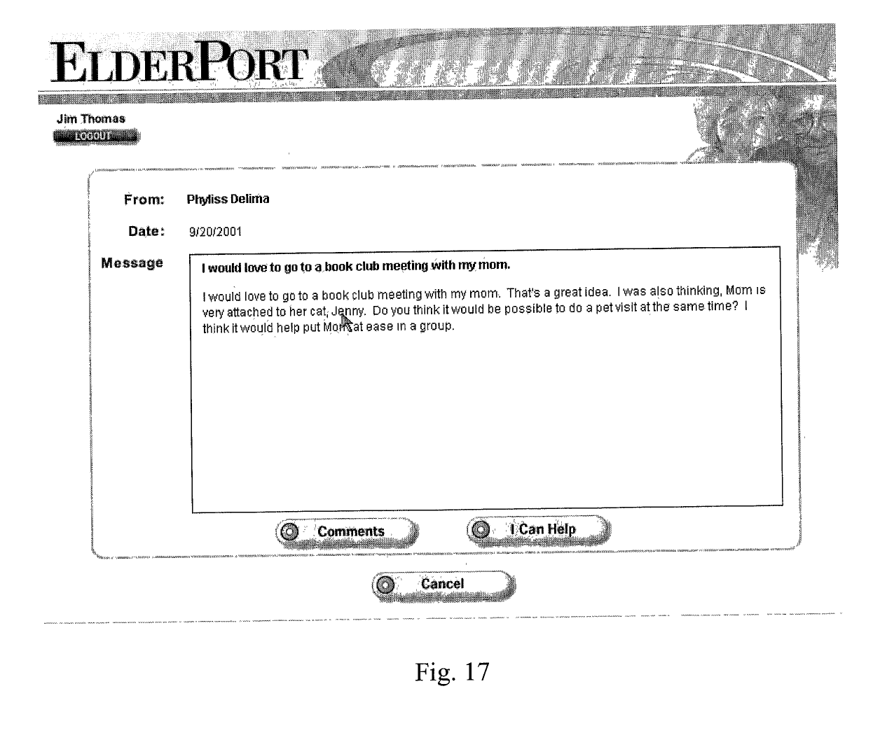

FIGS. 17-19 depict embodiments of various display screens that might be displayed to family members of an individual being cared for by the system in the course of the operation of the system. Along these lines, FIG. 17 depicts an display screen showing a message that has been received from a family member of an individual under the care of the system. The embodiment of the display screen shown in FIG. 17 includes action initiating buttons to permit the user to respond to the request with an “I CAN HELP” message which will cut off other potential respondents if clicked on. The user may also make comments on the request as well as cancel actions taken in response to the request.

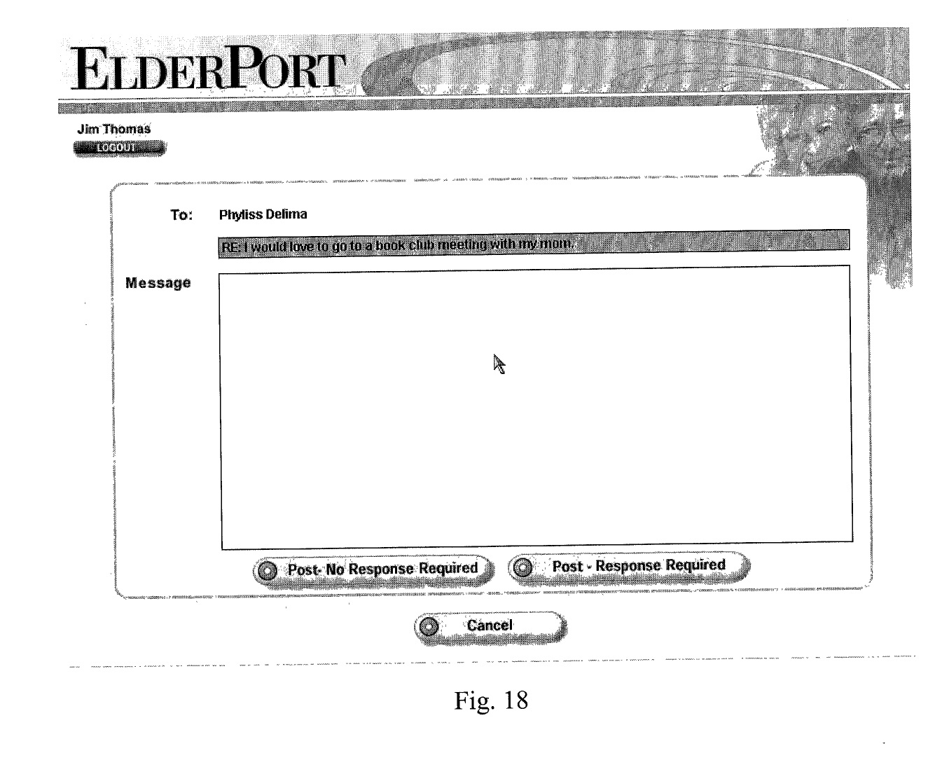

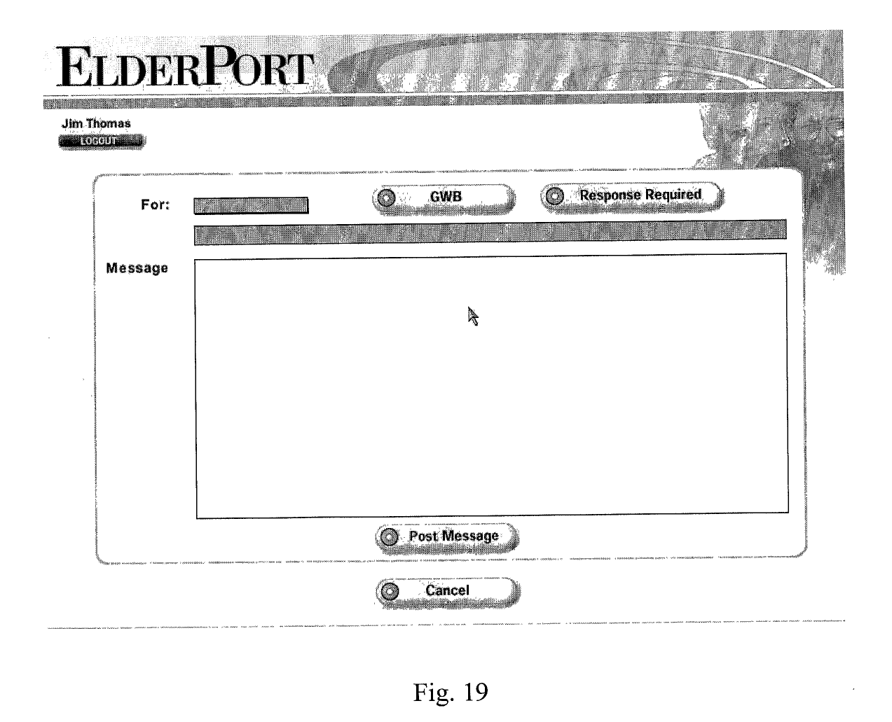

FIG. 18 represents an embodiment of a display screen that could be displayed to the user after clicking on the “I CAN HELP” button shown in FIG. 17. After formulating a response, the user may click on a button to send the post the response and indicate whether or not a response is required from the requestor. On the other hand, FIG. 19 illustrates an embodiment of a display screen that an employee of a care facility could view when choosing to post a message that is not in response to a request. The embodiment of the display screen shown in FIG. 19 also includes the possibility to post the message with a request for a response.

In the context of the embodiment of the Casual Workflow manager described above, the examples of Action Verbs provided above are described below in greater detail. “Announce” may initiate a non-actionable announcement. It can delineate a Conversation as being non-workflow oriented. An announcement can be made to one or more groups, and all are free to “Comment” on the announcement. A “Comment” can be a non-workflow message that can be introduced into either a workflow oriented Conversation or a non-workflow oriented Conversation.

An Announcement with Comments may be conceptually similar to a bulletin board except that it interacts with Smart View, so that the Announcement Conversation button is only visible to a user if that user has not read all of the message content. For example, a user might read an Announcement. After the user reads it, the Announcement button vanishes. Following that, another user reads the same Announcement and Comments on it. The Announcement button would then re-appear for the first user because there is new unread content. After the first user reads the new content, the button would disappear again.

“Request” may be employed to initiate a workflow-oriented Conversation. The request may be directed at one or more groups, including the Home Group. The system may be configured such that by default, all members of the user's Home Group may view and Comment on a Request. Anyone in a group to whom the Request is directed may respond via the “I Can Help” button. This button only appears on the displays of valid Respondents. Pressing “I Can Help” limits the Request to a dialogue between the Requestor and the Respondent. All other potential Respondents can no longer see the Conversation. This conversation can alternate back and forth between the Requestor and the Respondent via the “Response Required” button, in which a message is sent, and the other user is requested to respond to that message. At any time, users in the Home Group may add Comments. When the Respondent is ready for Closure, he/she presses the “No Response Required” button after entering a message. This enables the “Thank You” button on the Requestor's display, which closes the conversation.

An extension of this model is the “I Need Help” button, in which the Respondent can extend a Request on to another group. Anyone in that group who presses “I Can Help” becomes another Respondent to the original Request. This provides a simple, ad hoc mechanism for workflow routing which doesn't need to be planned out in advance. This routing mechanism can be invoked any number of times for a Request, each time adding an additional Respondent to the Request. Any valid Respondent can request Closure.

Finally, “Working” is functionally identical to “Response Required”, that is, it does not request closure. However, rather than indicating to the Requestor that a response is needed, it simply communicates that the Respondent is working on the issue, and that there will be further communication from the Respondent.

The above description of “Action Verbs” and other elements of the implementation of the Casual Workflow manager are simply examples included in an embodiment of the Casual Workflow manager. The details of the implementation may vary without departing from the basic idea of described above request submission and transmission and response generation and isolation of the respondent from other potential respondents. Care of individuals as described herein may be enhanced through the incorporation of the Causal Workflow manager.

In a system according to the present invention, an elder will likely want some of the files in his or her e-space to be accessible only to certain members of his or her support group. For example, the elder might want his/her doctor to be able to access her medical information. However, the elder would not want his/her banker to be able to access her medical information. Thus, the elder can grant access privileges to the doctor to view the elder's medical information, whereas the banker is not given privileges to view the elder's medical information. As another example, suppose an elder in a nursing facility has a distant cousin she hasn't seen in a while. The distant cousin feels guilty and wants to come to see the elder. The elder might want to let the cousin know the visiting hours. Thus, the cousin can be given privileges to access that kind of general non-personal information. However, the cousin won't be granted privileges to access the elder's more private files. Thus, the elder can uniquely tailor the access privileges to each of the various types of data files stored in his/her e-space to each member of his/her support group.

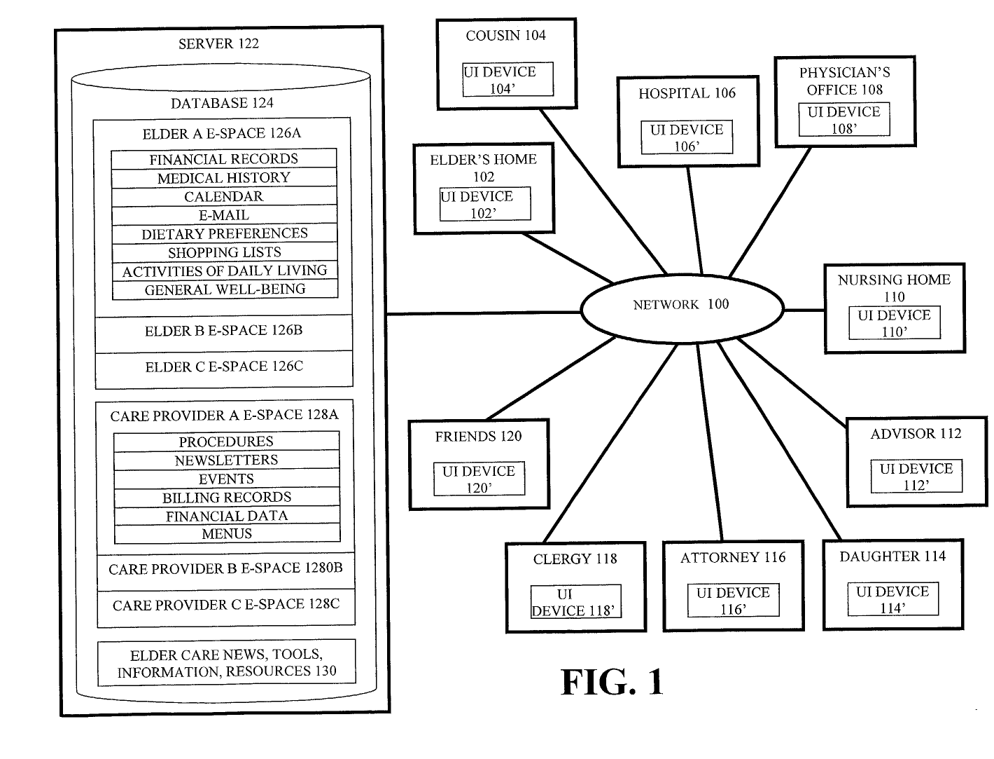

FIG. 1 depicts a block diagram for system architecture suitable for implementing the present invention. A server 122 runs a software program that implements the present invention. Server 122 includes a data storage device which stores database 124. Database 124 stores e-spaces 126 for many different elders. FIG. 1 depicts e-spaces for elder A, elder B, and elder C; each elder has an associated e-space 126A, 126B, and 126C, respectively. For purposes of example, some typical types of data files that can be included in an elder's e-space are depicted in FIG. 1 for elder A: financial records, medical history, calendar, e-mail, dietary preferences, shopping lists, activities of daily living, and general well being messages. This list is not exhaustive, and is given by way of example only. The functions of these different types of files will be described in more detail later.

Server 122 connects to network 100. Network 100 can be any network or communication media connecting terminals or user interface devices. For example, network 100 could be an intranet such as a local area network (LAN), or it could be a wide area network (WAN) such as the Internet. In one embodiment of the present invention, network 100 is the Internet, which allows individuals from anywhere in the world to conveniently access the elder's e-space. As an alternative to the Internet, any computer network or other communication media could be used to connect members of the elder's support group with the elder's e-space.

Family members such as cousin 104 and daughter 114 can access the elder's e-space by using user interface devices 104′ and 114′, respectively. User interface devices allow users to interact with network 100. Examples of user interface devices include computers, wireless devices, personal digital assistants (PDA's), cellular phones, and so forth. In one embodiment of the present invention, server 122 is connected to the World Wide Web. Any World Wide Web user can access the elder's e-space by entering a URL associated with server 122, such as http://www.elderport.com. The user then enters his or her log-in information to access the system.

In many cases, the elder him/herself will want to access his/her e-space, if he/she is capable. The present invention is designed to be used for elders who are residing in a variety of different care provider settings. In some cases, the elder may still be living at his/her own home. If so, the elder can access his or her own e-space via user interface device 102′ at the elder's home 102. The elder may have an assistant who periodically visits her home. The elder may wish to grant access privileges to her e-space to her assistant. The assistant could use a user interface device 102′ located in the elder's home, or any other user interface device capable of connecting to the network 100.

In addition to elders living at home, the system of the present invention can also be used by elders residing in some form of care provider facility. There are a variety of types of elder care provider facilities suited to the level of care required by the elder. Examples include nursing facilities, assisted living facilities, continuing care retirement communities, group homes, and so forth. Elders in any of these facilities can be provided with a user interface device to access their own e-space, if the elder is capable of using the user interface device.

FIG. 1 shows that nursing facility 110 has a user interface device 110′, which the elder or a staff member can use to access the elder's e-space. If the elder is admitted to a care provider site 106, the elder's e-space can be accessed through user interface devices 106′. If the elder goes to see a physician 108, the physician can access the elder's e-space via a user interface device 108′. Other individuals such as advisor 112, attorney 116, clergy 118, and friend 120 can access the elder's e-space via user interface devices 112′, 116′, 118′, and 120′, respectively.

Database 124 can also store other types of e-spaces. For example, a care provider can have its own e-space that contains information specific to the care provider. The care-provider e-spaces will be described in more detail later.

Database 124 also contains elder care news, articles, tools, information and other resources 130. This information forms the “public” portion of the web site of the present invention, and is described in more detail later.

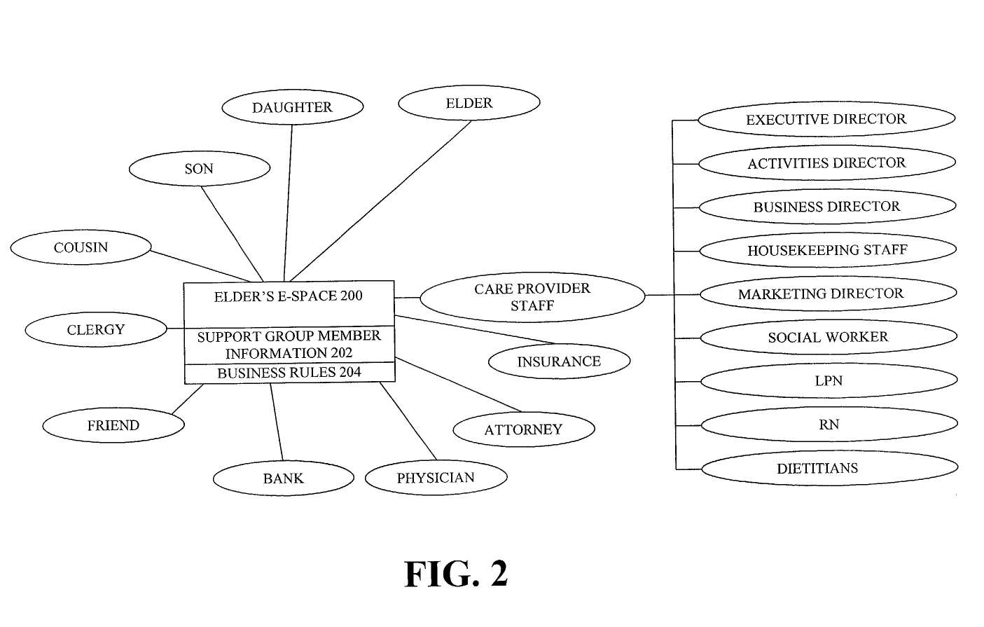

FIG. 2 depicts a block diagram that illustrates the logical relationships between the elder and his or her support group. The elder's e-space 200 occupies the center of the diagram. The members of the elder's support group are shown surrounding the centralized e-space 200. This illustrates that all of the members of the elder's support group can access one centralized data space from diverse locations.

As noted previously, the individuals who are able to access the elder's e-space are referred to as members of the elder's “support group.” The support group includes any individual who interacts with the elder and has a need to access at least some portion of the elder's e-space. Some typical members of a support group include family members, friends, clergy, financial advisors, physicians, attorneys, and insurance agents. If the elder is living in a care provider facility, the staff members of the care provider facility can also have access to the elder's e-space. Staff members can include dietitians, RNs, LPNs, social workers, marketing directors, housekeeping staff, business directors, activities directors, executive directors, certified nursing assistants, ombudsmen, etc.

Support group member information 202 is a set of data that is associated with the elder's e-space 200. Support group member information 202 contains identifying information for each member of the support group, such as name, e-mail address, relationship to elder, and other pertinent information. As will be described in more detail later, support group members can include individual members and group members.

Business rules 204 are also associated with the elder's e-space 200. Business rules 204 are rules that define access privileges for each individual member or group member in the elder's support group. For example, one business rule may specify that cousin Joe has access privileges to read the elder's “General Well Being” file, but the cousin can not view any of the elder's medical information. As another example of a business rule, a financial advisor can be given access privileges to view the elder's billing information, but not to view the elder's “General Well Being” file. An example of a business rule that specifies access privileges.

A simple business rule can specify whether an individual has privileges to view a file, and/or to edit a file. More complex business rules could specify whether an individual member can read a file, write to a file, delete entries in a file, or perform other types of operations, as specified. Business rules can potentially be even more complex. For example, a business rule could state that a banker can read the “Bank Account” file between 9:00 am and 3:00 pm.

As will be described in more detail later, the business rules can be created by the elder him/herself, if he/she is capable. Otherwise, the business rules can be performed by somebody who is responsible for taking care of the elder, a person who is called the “responsible party.” It is also possible that multiple people can be designated as responsible parties.

The system of the present invention differs from a typical computer by allowing an end user (for example, the elder or the responsible party) to grant privileges to access central server 122, rather than having a central server administrator grant such privileges. In a typical computer network, a server administrator is responsible for maintaining one or more central servers. The server administrator grants access privileges to the users of the computer network to allow the users to have limited access to the central server. The system of the present invention differs from this model by allowing a user for whom the e-space has been created to control the access of other users. The user (or an agent of the user) controls access to an e-space associated with the user stored on the central server. For example, an elder or responsible party can control access to the elder's e-space. Thus, an end-user performs the granting of access privileges, rather than a central server administrator.

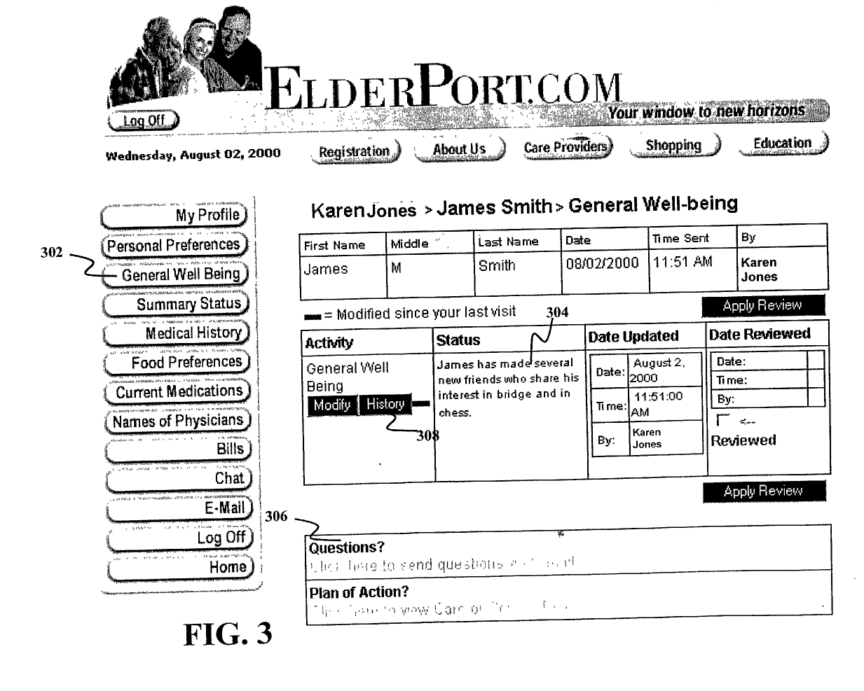

FIG. 3 shows an example of a display screen that is shown when a member of the elder's support group reads a message posted on the “General Well Being” file in the elder's e-space. The General Well Being space is an area where care provider staff members with access privileges can post messages about the elder's health, mood, and other general pieces of information about the elder. Here are some example messages:

“Nancy would like to see some of her old family photos. Please bring them when you visit next.”

“Nancy has made several new friends who share interests in Bridge and Chess”

“Jane has lost her slippers and she would really like a new pair”

The members of the elder's support group can see how the elder is doing by reading her General Well Being file. If the member saw a message stating that the elder was feeling sad, the member could arrange a visit to cheer up the elder. It should be noted that General Well Being is typically represented in the System as an Announcement-type Conversation. Users may Comment on it, but it does not represent a specific Request. Staff would typically make Requests to family using the “Request” Action Verb.

FIG. 3 depicts an example posting made by a nursing facility staff member named Karen Jones. Karen Jones is posting a message to a General Well Being file in an e-space for elder James Smith. James Smith lives in the nursing facility. Karen Jones has access privileges to post messages to James's General Well Being file. Karen is thus considered a member of James's support group.

Karen accesses James's General Well Being file by clicking on the General Well Being button 302. Karen posts a message 304 to James's General Well Being file that states “James has made several new friends who share his interest in bridge and in chess.” Any member of James's support group who has been granted access privileges to view James's General Well Being file can then view this message after it has been posted.

When a support group member views this message, if the member has a question about the entry, the member can click on Questions field 306, and an email message screen will be displayed. This e-mail message screen allows the support group member to send an email to Karen Jones asking a question about her General Well Being posting. Thus, the support group member can converse with Karen Jones and ask her for more information about that particular entry.

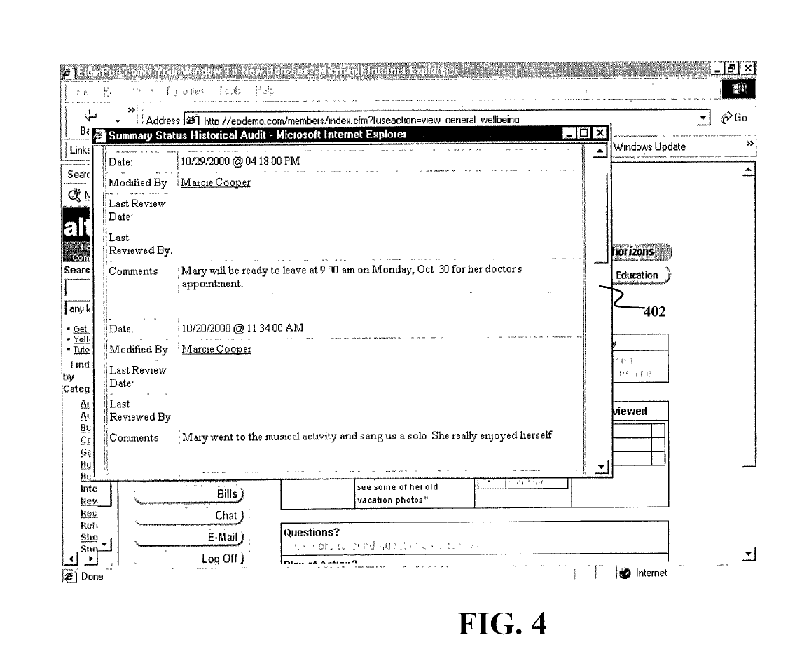

A support group member can also click on the “History” button 308 to view a chronology of postings in James's General Well Being file. FIG. 4 displays an example “History” screen for an elder's General Well Being file. A scroll bar 402 allows the support group member to scroll through a summary of messages that have been posted to the elder's General Well Being file. A nursing facility staff member named Marcie Cooper posted an entry on Oct. 20, 2000, stating that “Mary went to the musical activity and sang us a solo. She really enjoyed herself.” Marcie also posted an entry on Oct. 29, 2000, stating that “Mary will be ready to leave at 9:00 am on Monday, October 30 for her doctor's appointment.” This entry thus lets the elder's daughter know that the elder will be ready when the daughter arrives on Monday to pick up the elder. Thus, the General Well Being file allows Mary's friends and family to check in on how Mary is doing. The General Well Being file also provides information about upcoming events and important information related to those events.

A variety of other types of files besides “General Well Being” files can be included in the elder's e-space. A “Calendar/Events” file can include a schedule for the elder and a listing of upcoming events. A “Tasks” file could provide a list of tasks that need to be done concerning the support of the elder. For example, tasks could include bringing the elder a new pair of slippers, or arranging for the sale of the elder's home. Support group members could post messages and volunteer to perform specified tasks. Support group members could also post messages stating that there is a new task that needs to be performed, could someone volunteer? All of the support group members are thus informed about who has volunteered for various items. The elder's e-space could also include financial files, advance directives, location of key documents, insurance information, funeral wishes, and many other types of information. The elder may wish to grant access privileges to a financial advisor, attorney or banker.

Medical records and/or medical information, such as a complete list of current medications taken by the elder, can also be stored in an elder's e-space. Access privileges to view the medical records or information can be viewed by the elder's nurses, doctors, or any other individual that needs access. Medical information is especially useful to store in a centralized e-space. If the elder is in a nursing facility, the medical staff at the nursing facility can quickly and conveniently access the elder's medical records. If the elder has blood work sent to the lab for tests, the lab can access the elder's medical records and enter the results of the tests into the elder's medical records. If the elder visits a physician's office or hospital outside of the nursing facility, the physician or hospital can immediately be given access to the elder's medical information. If the elder is transferred from one care facility to a new care facility, the new care facility can immediately be given access to the medical information.

Information from the elder's data files in the elder's e-space can also be used to populate a “Minimum Data Set (MDS).” The MDS comprises assessment data captured, by an interdisciplinary team, at a care provider site, on a given Elder and reported periodically to the state. The MDS is electronically submitted to the state, in order for care provider facility to receive Medicare funding. Other types of statistics and data can be gathered by reviewing information in the elder's data files.

Other types of files that can be stored in the elder's e-space can include billing records, insurance information, legal information such as a will or living will, shopping lists, family tree/genealogy information, and religious preferences. The elder can also store personal files in her e-space such as a diary, photographs, music files, movies and so forth.

The files in the elder's e-space can include other information besides text. Support group members could be allowed to leave voice or audio messages, or post a movie clip. The elder's e-space can also include a variety of “tools” associated with the elder's e-space. For example, chat room capabilities are available to the elder, care provider and/or support group members. Members of the elder's support group can post messages in the chat room and communicate with each other in real time or participate in a moderated chat with care provider staff. Another example of a tool is email.

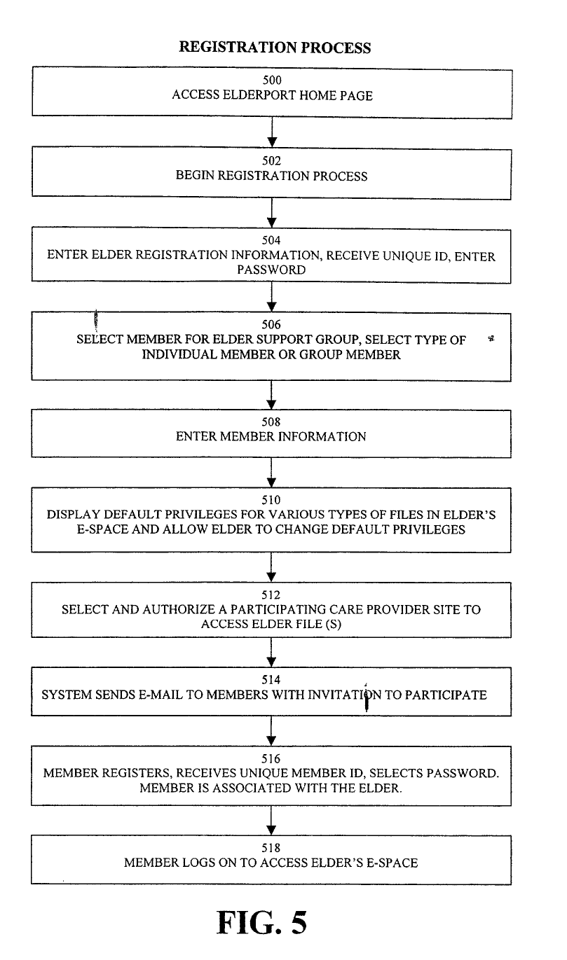

FIG. 5 depicts a flowchart illustrating a registration process. The registration process is performed when a new elder or responsible party decides to participate in the system. The registration process is performed by the elder or an agent of the elder called a “responsible party.” The registration process creates an e-space for that elder. The registration process also allows the elder or the responsible party to choose the members of the elder's support group and define the access privileges for each support group member.

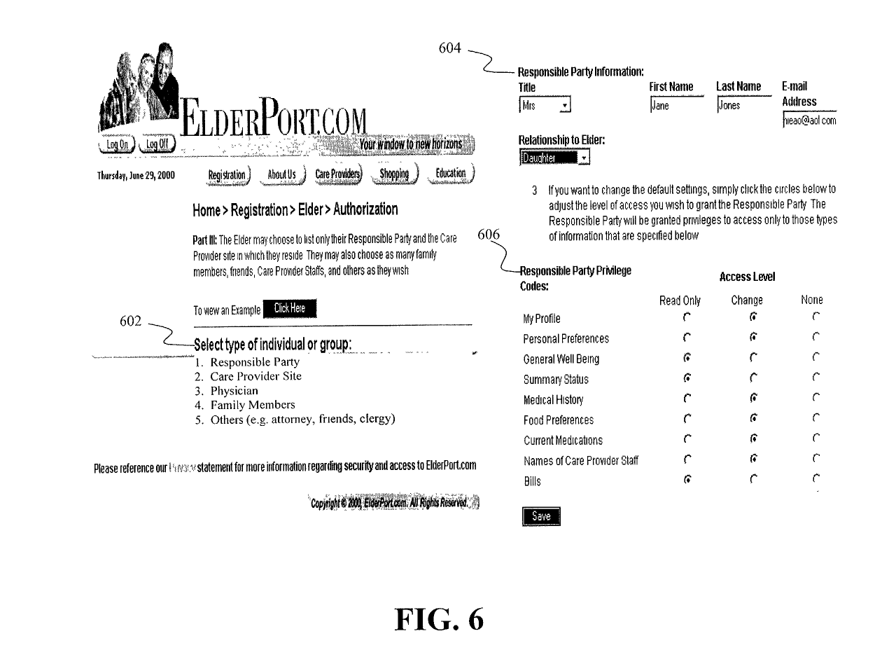

FIG. 6 depicts an example of a “registration” display screen. The registration process will now be described with respect to FIGS. 5 and 6. The registration can be performed by the elder, him/herself, if she is capable. A member of the care provider staff can help the elder perform the registration. For elders who are not capable of performing the registration, a responsible party can perform the registration for the elder, such as the elder's daughter or son. In the example that follows, it will be assumed that the elder is performing the registration.

In step 500, the elder accesses a home page associated with server 122, by entering a URL associated with server 122, such as http://www.elderport.com. The Elderport home page is then displayed. In step 502, the elder begins the registration process by performing an action such as clicking a “Registration” button.

In step 504, the elder is prompted to enter various types of registration information pertaining to the elder such as the elder's name, current address, phone number, age, and similar information. The elder can also be asked questions about the elder's living arrangements such as whether the elder is living at her own home or at a nursing home or at some other form of care provider facility.

Once the elder has completed entering registration information, he/she will be provided with a unique identification (ID) number by the system. The elder will be allowed to choose a password. The elder will need to enter his/her unique ID number and password to log on to the system in future sessions.

A e-space is created for the elder at this point. As described previously, the e-space contains various types of data files associated with the elder such as her general well being file, medical information, personal files, calendar file, prescriptions file, and so forth. The elder can be allowed to select which types of files she would like to include in her e-space.

Next, the elder selects the members of his or her support group beginning in step 506. In step 506, the elder selects a type of individual member or group member to add to his or her support group by clicking one of the listed options in the “Select type of individual or group” section 602 (shown in FIG. 6). Section 602 lists five different types of individual members or group members that can be granted access privileges.

If the elder wishes to add a “Responsible Party” member to his or her support group, then the elder clicks on “1. Responsible Party” in section 602. A “Responsible Party Information” section 604 then is displayed. In step 508, the elder enters member information for the responsible party such as the responsible party's name, e-mail address, and relationship to elder.

Additionally, a “Responsible Party Privilege Codes” section 606 is displayed. Section 606 displays a number of different types of data files that are stored in the elder's e-space. FIG. 6 shows the following examples of data files: My Profile, Personal Preferences, General Well Being, Summary Status, Medical History, Food Preferences, Current Medications, and Bills. These types of data files are by way of example only. Many other types of data files can be included, as described previously.

Responsible Party Privilege Codes section 606 allows the elder to specify particular access privileges for each type of data file for the responsible party. There are three types of access privileges shown in FIG. 6: “Read Only”, “Change”, and “None.” “Read Only” signifies that the member can read that type of data file, but cannot edit the file. “Change” signifies that the member may both read and edit that type of data file. “None” signifies that the member may not view at all that type of data file.

Other types of access privileges could alternatively be used. For example, access privileges of “Add” and “Delete” could be used. “Add” signifies that the member can add new information. “Delete” signifies that the member can delete existing information. As mentioned previously, it is also possible that the system could allow complex business rules to be created, such as “Joe can read the General Well Being file on weekdays but not on weekends,” or “Brad can create calendar entries for December but not for January.”

Each type of data file is initially set to have particular default access privileges. For example, FIG. 6 shows that the “My Profile” file is initially set to have default access privileges of “Change.” Additionally, “Personal Preferences” is initially set to “Change,” and “General Well Being” is initially set to “Read Only.” In step 510, the elder may then choose to change any of these default access privileges for any type of data file, by clicking in the appropriate circle. In one embodiment of the system, the “General Well-Being” file can only be written to by care provider staff members. The elder does not have the ability to change this default setting.

The original default settings shown for each type of data file will vary depending on the type of member being created (i.e. the option selected in section 602). For example, if the elder selects “4. Family Members” in section 602, then the elder has chosen to register a family member as part of his or her support group. A family member will have a different set of default privileges than a responsible party member or a physician.

In addition to granting privileges to individual members, the elder can also grant privileges to group members. One example of a group member is the staff at a care provider facility where the elder is residing. If the elder is living at a care provider facility, the staff at the care provider facility should be able to access the elder's e-space. However, staff members should not all have the same amount of access. For example, the nurses should have different access privileges than the housekeeping staff. The nurses may be allowed to access the elder's medical files, while the housekeeping staff are only allowed to view the elder's calendar.

The system of the present invention provides the elder the ability to select the care provider facility staff as a group member of his/her support group. By making this selection, the elder automatically delegates privileging power to another individual to grant privileges to each individual member within the group member. For example, if the elder is residing at a care provider facility, the elder can delegate privileging power to an administrator or an official at the care provider facility to grant privileges to each individual staff member at the care provider facility. The administrator/official at the care provider facility then grants privileges to all of the individual staff members within the care provider facility.

As will be explained in more detail later, the administrator can also grant privileges to “roles” within the facility, such as granting a set of access privileges to “housekeeping staff” or “RNs.” All of the individual members within the housekeeping staff would then be given the same set of access privileges. The “role” is actually a subgroup of larger care provider facility group. Potentially, the system could create subgroups within subgroups within subgroups, and so forth, each subgroup having a common set of access privileges.

An example of how the elder grants access privileges to the care provider facility as a group member will now be described. If the elder is living at a care provider facility, the elder can select “2. Care Provider Site,” in section 602. This will bring up a display window showing a list of participating care provider facilities. In step 512, the elder can scroll through the list and choose the care provider facility site where he/she is residing.

By choosing a care provider facility site, the elder has accomplished two things: 1) the care provider facility becomes a group member of the elder's support group and thereby is given authorization to access the elder's e-space, and 2) the elder has automatically delegated authority to an administrator or other official at the care provider site to create access privileges for all the staff members at the care provider facility. For example, the administrator at the care provider facility can assign a certain set of privileges to the housekeeping staff that are different from the registered nurses. By allowing the elder to delegate privileging power to an administrator at the care provider facility, the elder does not have to individually grant privileges to every single staff member at the care provider.

Once the elder has completed the process of granting privileges to all the members of his or her support group, the initial registration and set-up is concluded. From this point on, the elder need only to log on and provide their unique ID and password to access their files in the e-space.

In step 514, the system automatically sends e-mail to each member of the elder's support group. The e-mail will inform the member that he or she has been invited to participate in the elder's support group. The e-mail will also include the unique ID associated with the elder, an activation code, and provide instructions for logging in to the system and accessing the elder's e-space. For an example, server 122 can send an email to support group member Bill Brown which reads, “Dear Mr. Brown, you have been invited by your mother to participate in ElderPort. Please visit http://www.Elderport.com. The following is an activation code and elder ID that you will need to access the ElderPort system for your mother.”

In step 516, the member can access the elder's e-space by visiting the Elderport home page and registering themselves. The member will first receive his or her own unique ID and be asked to enter a password. After successfully completing these steps, they will associate themselves with the elder by entering the elder ID and the activation code and their own unique identification number. Thereafter, the member needs only to log on with their own unique member ID and password to access their elder's file according to the privileges established by the elder or responsible party. This is represented in step 518.

The elder and/or responsible party may change access privileges for any existing support group member at any later time. The elder and/or responsible party can click on a button entitled “Change Access Privileges” and go in and edit the access privileges for any member. The elder and/or responsible party can also edit any of the elder's profile information such as address, telephone number, and so forth.

The registration process just described is an on-line registration process. An offline registration process could also be performed. With an offline registration process, the elder and/or responsible party fills out all of the registration information and sends the registration to a server administrator who operates server 122. The registration information can be sent via mail, fax, telephone, or any other form of communication. The server administrator then enters the registration information into the server 122. An administrator/official who has been given privileging power for staff members at the facility could also send in by an offline method a list of privileges for each staff member within a group.

If an elder is capable, the elder may want to select the access privileges for each member of her support group. The elder may decide to allow one or more responsible parties to have the power to set access privileges for members of her support group. If the elder's condition deteriorates, it may become a necessity to have one or more responsible parties take over control over the elder's e-space.

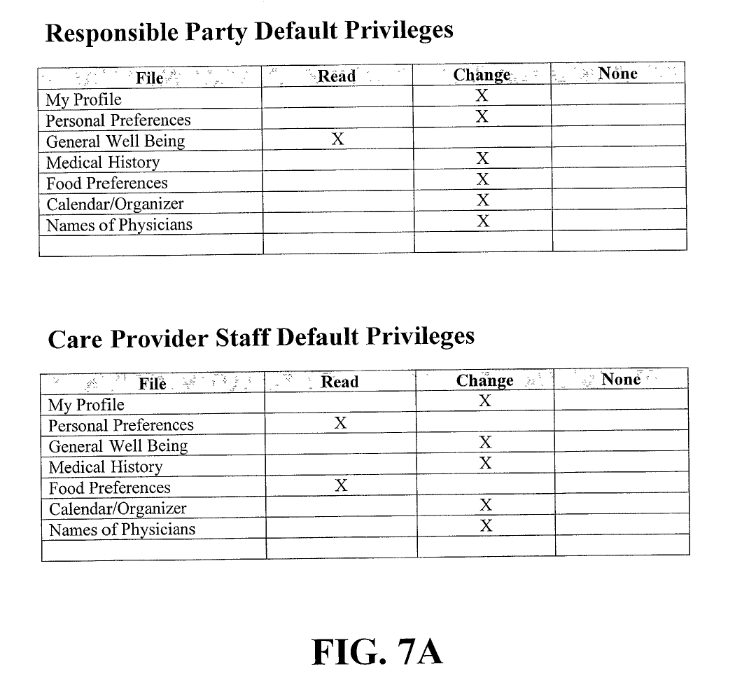

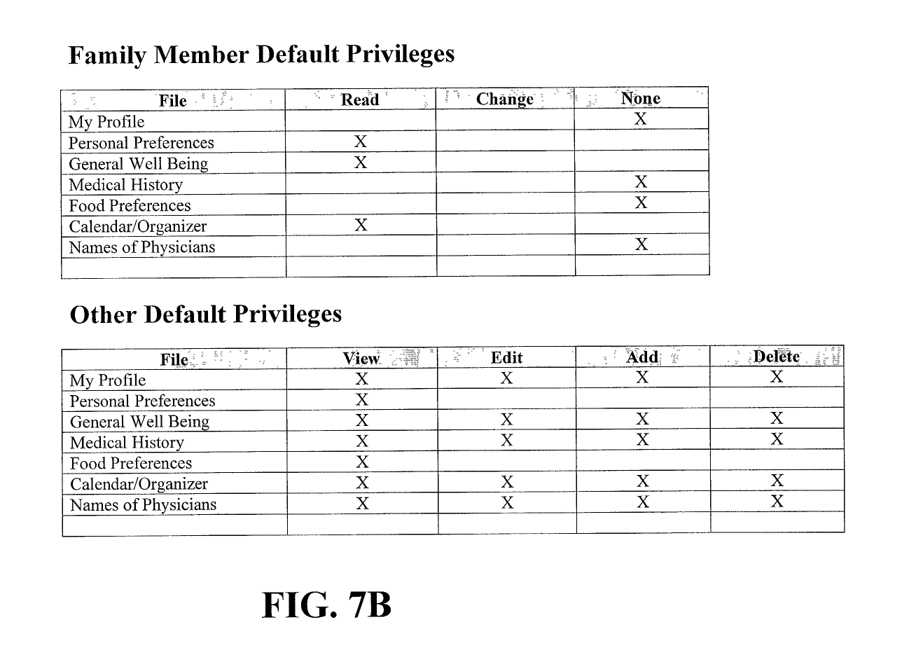

FIGS. 7A and 7B depict some example default privilege settings for various types of files. FIG. 7A depicts example default privilege settings for a Responsible Party and for Care Provider Staff. Privilege levels include the ability to view, edit, add, and/or delete. FIG. 7B depicts example default privilege settings for a Family Member. FIG. 7B also depicts example default privilege settings for others such as associates, friends or parties interested in the elder's care using the privilege levels: view, edit, add, and delete.

During the elder's lifetime, the elder may move to a number of different residences or care provider institutions. As the elder's health deteriorates, the elder may need to be moved to a series of care provider facilities that provide a successively increasing amount of care. For example, an elder may start out living at home with the help of an assistant that visits periodically. The elder may eventually move to a senior residential community that provides some assistance. As the elder's health deteriorates, the elder may have to move to a nursing facility. One of the advantages of the present invention is that the elder's files are all located on centralized server 122. The elder thus does not need to carry his or her medical information or other personal information from one institution to the next. When the elder gets transferred to a new facility, the elder or responsible party can grant new access privileges to the new facility and remove access privileges from the old facility. Thus, all of the elder's files will be instantly accessible to the new facility. Some of the elder's files may be specific to the old care provider facility, and would not get moved to the new facility. For example, the elder may have a schedule of daily events that only applied to the old facility. These records would either be deleted or marked as old when the elder gets moved to the new facility.

Server 122 can store other types of e-spaces in addition to elder e-spaces. For example, as shown in FIG. 1, server 122 can store care provider e-spaces 128. Care provider e-spaces 128 store files owned by the care provider, rather than being owned by the elder, such as employee newsletters, events, billing information, policies/procedures, employee benefit information, recruiting information, mandatory training videos, tracking of staff compliance reports, staff schedule and call Rosters, job opportunities, and announcements.

As with elder e-spaces 126, the files in the care provider e-space 128 are privileged, so that only individuals with access privileges to a particular file can read and/or edit that file. The access privileges for the care provider files are granted by one or more administrators or officials at the care provider who has the authority to grant access privileges.

An entire care provider corporation can also have its own e-space. For example, one care provider corporation might have twenty-five nursing facilities located around the country. The entire corporation could have its own e-space to facilitate business transactions and operations and communicating general or marketing information to the general public. The entire e-space for the corporation could be subdivided into portions dedicated to individual nursing facility s within the corporation.

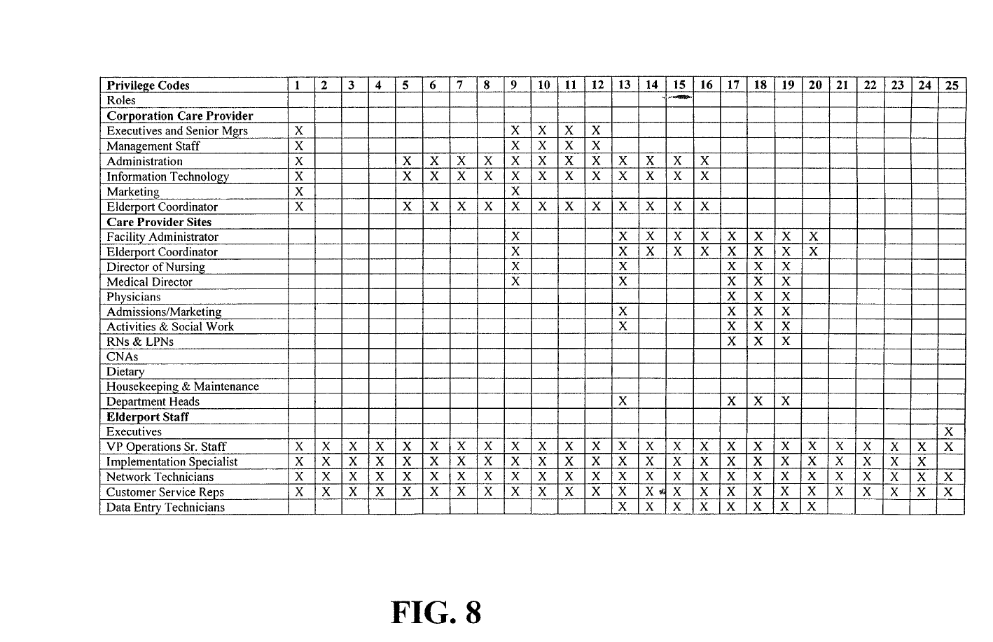

FIG. 8 depicts an example of a table specifying a set of default privileges that are granted to the care provider staff according to their roles. Each row represents a “role” at the care provider. The “role” actually represents a group of individuals with a specific job title. Each column represents a specific access privilege. Some examples of privilege codes:

1: View General Well Being Messages

2: Edit General Well Being Messages

3: Add General Well Being Messages

4: Delete General Well Being Messages

5: View Medical Information

6: Edit Medical Information

7: Add Medical Information

8: Delete Medical Information

Every elder in a care provider facility has a table associated with that elder like the example table shown in FIG. 8. The table specifies the access privileges of staff members by role. The privileges specified by the table last the duration of time that the Elder resides in the facility.

By granting access privileges to a “role,” the whole group of individuals with that role is given a set of particular access privileges. Additionally, specific individuals within that group could be granted special additional privileges, which are either more or less restrictive. For example, a set of RNs within a care provider corporation can be given access privileges to view a “procedures” file. However, one specific RN named John Doe can be given access to edit the “procedures” file. Another RN named “Rob Smith” is not given any access to the “procedures” file, even for viewing.

As mentioned previously, the granting of privileges to each “role” is typically performed by an administrator or other official at the care provider facility. The elder delegates the power to the administrator/official to grant privileges for each staff member role.

Each elder at a care provider facility has a unique privileging table like the one shown in FIG. 8 associated with that elder. There could also be other tables that specified access privileges for the staff with respect to other types of e-spaces, such as the care provider e-space. For example, the administrator could grant privileges to the housekeeping staff to view “Newsletters” but not to view “Tax Records.”

Server 122 also provides a wealth of information and resources related to elder care. This portion of the web site is referred to as the “Public” portion of the site, because anyone visiting the site can access this information without registering or paying a fee. The e-spaces, on the other hand, form the “Private” portion of the site, which are only accessible to those who have registered and have been granted access.

Any user who accesses the home page associated with server 122, http://www.elderport.com, can access the information and resources available. The resources include news and articles about issues germane to elders and the aging population, elder care, links to other Internet sites, on-line tools, and other types of resources related to elder issues.

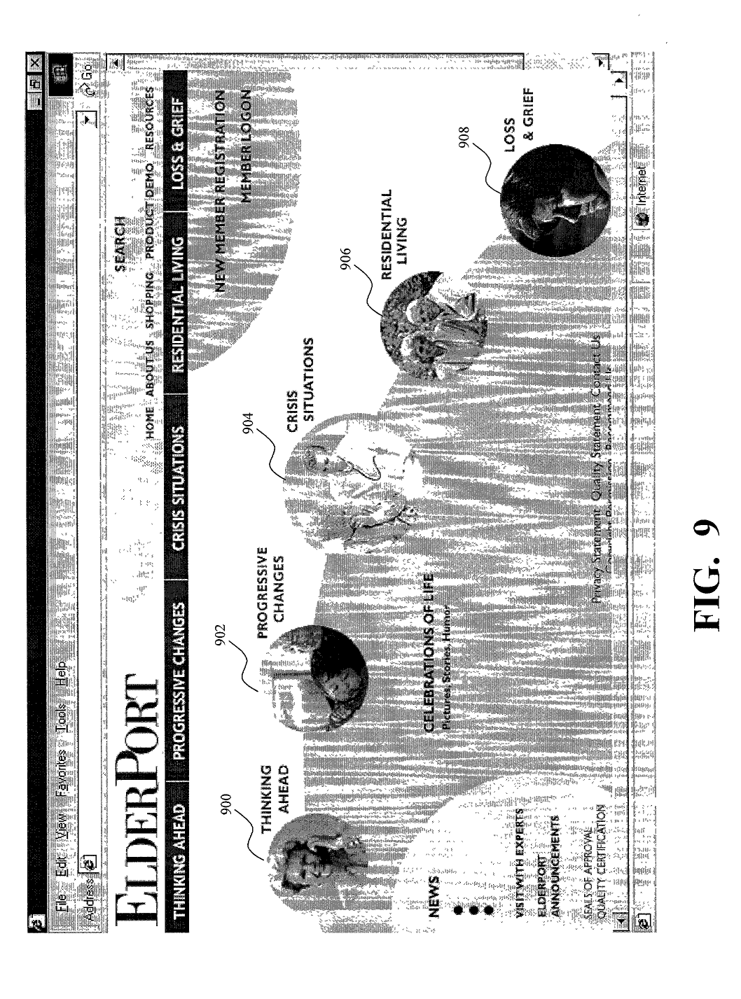

FIG. 9 shows a sample home page that provides resources for Internet users facing a variety of different elder-care situations and problems. The resources are divided into five different categories. The user can choose a category based on the stage of care of the elder.

The first stage is called “Thinking Ahead.” If a user of the web site does not have an immediate elder issue, but is starting to plan for their retirement years, the user can click on “Thinking Ahead” link 900. This will provide general information and resources to the user concerning health and wellness issues, retirement planning, wills and trusts and what to expect as the body ages. If a user has a mother or father who is starting to develop health problems or starting to show signs of deterioration, the individual knows that some course of action will have to be taken soon. In this case, the individual can click on “Progressive Changes” link 902. This stage is often very difficult for people to face because they have to decide whether they are going to put their mother or father in a nursing facility or a similar type of care provider facility.

When crisis situations occur, it is many time difficult to find the resources needed to help resolve difficult problems relative to elder issues. For instance, the daughter has 48 hours to find a nursing facility to place her mother who it was determined could not go home from the hospital, but needs extra nursing care. Medicare finding is running out. This is just one problem for which the user may need their questions answered problem immediately. The “Crisis Situation” can be reached by clicking on link 904 of the web site will provide this information through a variety of forums. This section will provide the individual with information, resources, and checklists that will give the individual immediate help and advice for taking quick action to resolve the crisis.

A user can click on “Residential Living” link 906 to receive information concerning finding and choosing some sort of assisted living, skilled nursing, or similar facility. The user can learn what to expect from different kinds of facilities and how to deal with different kinds of problems and issues. The user can also learn about patient rights and similar types of information related to the various types of care provider environments.

Lastly, a user can click on “Loss & Grief” link 908 to view information and resources for dealing with the loss of a loved one or loss of independence. The user is provided with information on funerals and dealing with the grief or the loss of a loved one.

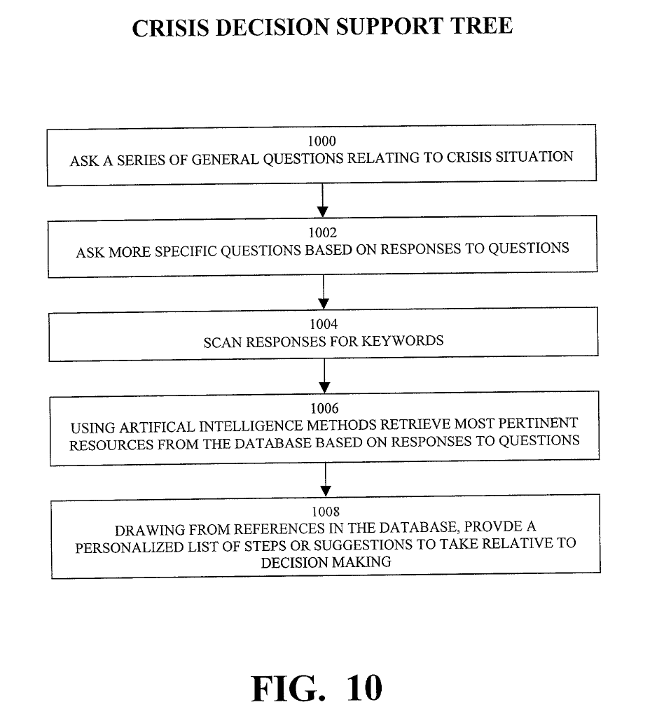

Another feature provided by the web site of the present invention is a Decision Support Crisis Assistance Tool. The Crisis Assistance Tool is an interactive tool that helps a user deal with a elder-care crisis situation by using a type of artificial intelligence methodology to ask questions of the user for which the system provides personalized responses based on their unique circumstances. FIG. 10 depicts a flowchart illustrating a process performed by the crisis assistance tool. In step 1000, a visitor to the web site is asked a series of questions about his or her crisis. The questions are either yes/no answers or multiple choice. For each question provided, the user is asked to submit a response. The response can be a yes/no response. Alternatively, the user can select one or more choices provided to the user. Some examples of questions could be:

Does the Elder live alone?

Is the elder over the age of 90?

Does the Elder have Medicare Part A and B?

Does the Elder have current disabilities?

After the user answers these general questions, in step 1002, the user is asked more specific questions based on his or her responses to previous questions. For example, if the user answered “YES” to the question “Does the elder have a current disability(ies)?” then the next question could be: “Please select type(s) of disabilities?

In addition to receiving YES/NO and multiple-choice questions, the user could also be allowed to enter text responses. If the user enters text responses, then in step 1004, server 122 scans the response to identify keywords in the response.

After the user has answered all of the questions, in step 1006 server 122 retrieves resources from the database that are of the most use to the user's situation based on the user's responses to the questions. The user can be provided with articles, links, tools, and other resources stored in database 124 all directed towards the user's unique situation.

The user can also be provided with a list of real-life scenarios. These are scenarios about people with similar situations. The scenarios describe what actions were taken, and what actions were effective. For example, one scenario describes a lady who lives alone at her home in Denver. She has one daughter in Minneapolis. She fell and broke her hip. A list of actions of what the daughter needs to do or think about are provided. Thus, the user can read these scenarios and compare the scenario with his or her own situation and thereby learn what actions they should consider in making their own decisions.

A server included in any system according to the present invention may be operable to carry out any aspect of the present invention described herein, including the Casual Workflow manager. The present invention may also include a computer program product that includes a computer readable medium that stores computer program instructions that can carry out any aspect or any step of the invention as described herein.

Although the present invention has been described in terms of various embodiments, it is not intended that the invention be limited to these embodiments. For example, the system and method of the present invention is not limited to the long-term care industry. The present invention could be applied to the care of any individual such as a sick or disabled person residing in any healthcare facility. As another example, the present invention could be adapted for use for a young child. The young child would have his or her own e-space containing a set of files associated with the child. A responsible party such as a parent, trustee, or guardian, could help the child operate the e-space. As another example, a financial institution such as a bank could create an e-space for each customer. The customer would set access privileges for individuals given access to his or her e-space. The e-space could contain financial statements, stock prices, bond prices and so forth. Modification within the spirit of the invention will be apparent to those skilled in the art. The scope of the present invention is defined by the claims that follow.

1. A method for dynamically managing workflow without preprogrammed workflow rules, the method comprising:
receiving a request from a user;
transmitting the request to at least one group of potential respondents;
transmitting a response to the user from one respondent of the at least one group of potential respondents; and
limiting the at least one group of potential respondents to the request to the one respondent to prevent additional respondents from responding to the request.

2. The method for dynamically managing workflow according to claim 1, wherein the user selects the groups of potential respondents to transmit the request to.

3. The method for dynamically managing workflow according to claim 1, wherein the request is transmitted to a plurality of groups of potential respondents.

4. The method for dynamically managing workflow according to claim 1, further comprising:
indicating to the user that a response has arrived from a potential respondent.

5. The method for dynamically managing workflow according to claim 4, further comprising:
after the user has viewed the response deleting the indication to the user that a response has arrived from a potential respondent.

6. The method for dynamically managing workflow according to claim 1, wherein information concerning the request flows between the user and the respondent until the request is resolved.

7. The method for dynamically managing workflow according to claim 1, further comprising:
receiving comments from members of a users group authorized to view the user's request.

8. The method for dynamically managing workflow according to claim 1, further comprising:
transmitting the request from the respondent to at least one of members of the respondent's group and another group of respondents.

9. The method for dynamically managing workflow according to claim 1, further comprising:
transmitting a termination message from the respondent to the user when the request has been satisfied.

10. The method for dynamically managing workflow according to claim 1, wherein the request and the response are communicated over the internet or an intranet.

11. The method for dynamically managing workflow according to claim 1, wherein the workflow facilitates coordination of care of an individual.

12. The method for dynamically managing workflow according to claim 1, further comprising:
storing data associated with a cared-for individual in a data storage device coupled to a server, the server accessible by a plurality of user interface devices via a communication media; and
receiving a business rule associated with the data over the communication media transmitted from one of the plurality of user interface devices, the business rule specifying access privileges of a member user.

13. The method for dynamically managing workflow according to claim 1, further comprising:
displaying to the user only information and controls relevant to the user.

14. The method for dynamically managing workflow according to claim 13, further comprising:
sorting the information in order of importance.

15. A system for dynamically managing workflow without preprogrammed workflow rules, the system comprising:
a server connected to a communication media and operable to receive a request from a user, transmit the request to at least one group of potential respondents, transmit a response to the user from one respondent of the at least one group of potential respondents and limit the at least one group of potential respondents to the request to the one respondent to prevent additional respondents from responding to the request, wherein the server is accessible by a plurality of user interface devices connected to the communication media.

16. The system according to claim 15, wherein the server is further operable to store data associated with a cared-for individual and at least one business rule associated with the data, the business rule being created by a user at one of the plurality of user interface devices, the business rule specifying a level of access privileges of a member user.

17. The system according to claim 15, wherein the communication media is a local area network or a wide area network.

18. The system according to claim 15, wherein the system facilitates coordination of care of an individual.

19. A computer program product for performing a process of dynamically managing workflow without preprogrammed workflow rules in a system, the computer program product comprising:
a computer readable medium; and
computer program instructions, recorded on the computer readable medium, executable by a processor, for performing the steps of:
receiving a request from a user;
transmitting the request to at least one group of potential respondents;
transmitting a response to the user from one respondent of the at least one group of potential respondents; and
limiting the at least one group of potential respondents to the request to the one respondent to prevent additional respondents from responding to the request.

20. The computer program product according to claim 18, wherein the computer program instructions further perform the steps of:
storing data associated with a cared-for individual in a data storage device coupled to a server, the server accessible by a plurality of user interface devices via a communication media; and
receiving a business rule associated with the data over the communication media transmitted from one of the plurality of user interface devices, the business rule specifying access privileges of a member user.

21. A system for performing a process of dynamically managing workflow without preprogrammed workflow rules in a system, comprising:
a processor operable to execute computer program instructions; and
a memory operable to store computer program instructions executable by the processor, for performing the steps of:
receiving a request from a user;
transmitting the request to at least one group of potential respondents;
transmitting a response to the user from one respondent of the at least one group of potential respondents; and
limiting the at least one group of potential respondents to the request to the one respondent to prevent additional respondents from responding to the request.

22. The system according to claim 21, wherein the memory is further operable to store computer program instructions for performing the steps of:
storing data associated with a cared-for individual in a data storage device coupled to a server, the server accessible by a plurality of user interface devices via a communication media; and
receiving a business rule associated with the data over the communication media transmitted from one of the plurality of user interface devices, the business rule specifying access privileges of a member user.
